(19) United States
(12) Patent Application Publication
(10) Pub. No.: US 2023/0375010 A1
(43) Pub. Date: Nov. 23, 2023

(54) SEPARATOR ELEMENT

(71) Applicant: HYDAC TECHNOLOGY GMBH, Sulzbach/Saar (DE)

(72) Inventor: Norbert WEBER, Saarbrücken (DE)

(21) Appl. No.: 18/031,029

(22) PCT Filed: Jan. 5, 2022
(86) PCT No.: PCT/EP2022/050109

§ 371 Date: Apr. 10, 2023

(30) Foreign Application Priority Data
Feb. 13, 2021 (DE) 10 2021 000 744.1

(51) Int. Cl. F15B 1/14; B32B 25/04

(52) U.S. Cl. CPC F15B 1/14; B32B 25/042; F15B 2201/205; F15B 2201/3151; F15B 2201/3155; F15B 2201/3156; F15B 2201/61; B32B 2307/51

(57) ABSTRACT

1. Separator element

2. A separator element consisting of at least two types of layers of plastic material,
one type of which layers is media resistant to mineral oils; and
the other type of which layers has low permeability to gases or is gas-tight,
   wherein the two types of layers are firmly bonded to each other when in direct contact and form the elastically flexible separator element (12).

The invention relates to a separator element, in particular for use in pressure accumulators, such as diaphragm accumulators.

DE 10 2014 000 358 A1 discloses a pressure accumulator having a diaphragm forming a movable separator element between media spaces, which diaphragm is made from superposed layers of different materials. In a preferred embodiment, provision is made for the diaphragm to comprise in succession
a layer of nitrile rubber (NBR) having an adhesive rubber coating;
a barrier layer of ethylene-vinyl alcohol copolymer (EVOH);
an impregnating layer of polyvinyl acetate (PVAc);
a substrate;
an impregnating layer of polyvinyl acetate (PVAc);
a barrier layer of ethylene-vinyl alcohol copolymer (EVOH);
a layer of adhesive gum;
a barrier layer of ethylene-vinyl alcohol copolymer (EVOH);
an impregnating layer of polyvinyl acetate (PVAc);
a second substrate;
an impregnating layer of polyvinyl acetate (PVAc);
a barrier layer of ethylene-vinyl alcohol copolymer (EVOH); and
an adhesive rubber coating on a layer of nitrile rubber (NBR).

The respective substrates used in the laminate have individual filaments, wherein filaments are enclosed by penetration of the impregnating layers, achieving an intimate, non-detachable bond with consistently high permeation resistance between the gas-tight impregnation and the filaments of the substrate. In this way, the risk of cracks forming in the course of operation due to the flexing movements that the diaphragm inevitably undergoes inside the pressure accumulator during operation and, as a result, of the gas-tight impregnation detaching or flaking off from the substrate is effectively countered. It is of particular advantage if the substrate is formed from a woven fabric, knitted fabric, interlaced fabric or non-woven fabric made of plastic, wherein a plastic fabric made of polyamide (PA6.6), formed from the filaments, is used.

The known multilayer solution for an elastically flexible separator element is intended to ensure, in the context of an application in pressure accumulators, that the process gas stored in the pressure accumulator, such as nitrogen gas, cannot reach the liquid side of the accumulator containing the mineral oil. Otherwise, the nitrogen unintentionally reaches the oil side of the accumulator by first diffusing into the elastomer material of the separator element element and then escaping into the environment toward the liquid side of the pressure accumulator while evaporating. In this way, the amount of gas present in the accumulator system decreases and its functionality decreases rapidly, rendering the accumulator system unusable, which then typically cannot be reused, but rather has to be disposed of.

The multilayer structure, including coatings as layer material, achieves a correspondingly high permeation resistance and gas tightness; however, the known solution is extremely costly to manufacture and, due to the large number of layers, delamination processes cannot be excluded, which would render the membrane-like separator element unusable in use, at least in the long term.

Further separator elements can be found in EP 0 927 631 A1, U.S. Pat. No. 5,653,263 A, DE 16 00 621 A1, DE 82 26 197 U1, DE 32 19 530 A1 and U.S. Pat. No. 5,618,629 A.

Based on this prior art, the invention addresses the problem of creating a separator element, which, on the one hand, is resistant to media and, on the other hand, has a high permeation resistance with simple manufacture and in a cost-effective manner.

A separator element having the features of claim 1 in its entirety solves this problem.

The separator element according to the invention consists of two types of layers of plastic material,
one type of which layers is media resistant to mineral oils; and
the other type of which layers has low permeability to gases or is gas-tight,
   wherein the two types of layers are firmly bonded to each other when in direct contact, resulting in the elastically flexible separator element.

In this way, a separator element can be designed in a cost-effective manner using only two different layer materials, wherein the wall thickness of the separator element is correspondingly thin compared to the known solution, which improves the elasticity for the separator element. In particular, when the separator element is used in a pressure accumulator, such as a diaphragm accumulator, and flexed hard, no unintentional delamination of the two types of individual layers occurs, i.e., the long-lasting use for the separator element is ensured.

In a preferred embodiment of the separator element according to the invention, a provision is made for a layer of the other type to be accommodated between two layers of the one type across the entire surface. In this way, a sensitive layer of low permeability to gases or a gas-tight layer can be protected from damage; in particular, unintentional tearing or detachment from the adjacent layer of the one type being media resistant can be avoided. If necessary, more than three layers can be bonded together in alternating sequence to increase the tightness of the separator element, wherein preferably again the outermost layers in the laminate should be resistant to mineral oils.

Preferably, the media-resistant layer of one type is made of epichlorohydrin rubber, which is highly resistant to mineral oils. Owing to the low compression set of the NBR rubber, high permeation resistance to gases is also achieved. The hardness range for this layer is between 40 and 90 Shore A.

Preferably, the layer of the other type having a high gas permeation resistance is made of isobutene-isoprene rubber. This rubber is also known as butyl rubber (butyl) and is a polymer of the group of synthetic rubbers. The hardness of this rubber material is regularly between 40 and 85 Shore A. In addition to the low gas permeability, it is advantageous that this layer behaves extremely elastically, especially at low temperatures. A disadvantage is the almost non-existent resistance to oils and greases, which does not matter, however, since in this respect the middle layer is covered by the layers of epichlorohydrin rubber (ECO).

For use of the separator element according to the invention in an associated diaphragm accumulator, preferably a provision is made for the bonded types of layers to form a shell body, preferably in the manner of a half shell. To secure the separator element in the diaphragm accumulator, it is also preferred that the half-shell-shaped laminate forms a thickened rim at its free end, formed from layers of one type, into which the free end of the layer of the other type opens out. The thickened rim provides a fixed support for the separator element within the diaphragm accumulator. The other membrane parts can move freely in the interior of the diaphragm accumulator and separate a liquid space from a gas space in the accumulator housing in a media-tight manner.

A preferred method of making a partition element described above is to have each type of layer as a sheeting; and to bond the layers together by thermoforming to form the shell body. The thermoforming process then involves a vulcanization step, in which the various layers are firmly bonded together. The forming into a shell shape is based on the inner contour of the diaphragm accumulator in which the separator element will later be used.

In another type of manufacturing process according to the invention, provision is made for the respective type of a layer to take the shape of the shell body to be produced as a partial body by means of thermoforming, and for the individual partial bodies obtained in this way to be subsequently bonded together, forming the shell body as a whole, again by vulcanization. In this respect, too, the contour of the shell body of the separator element follows the inner contour of the diaphragm accumulator, in which the separator element is later to be used.

In any case, it has been shown to be advantageous to have the thermoforming or vulcanizing process followed by a tempering step, which generally describes the heating of a material, in this case the laminate, over a longer period of time to be able to relieve any mechanical stresses that may occur in the components. This type of heat treatment in the form of annealing effectively counteracts any possible delamination of the individual layers in the laminate.

As explained above, the separating layer can be used particularly preferably in a hydraulic accumulator, such as a diaphragm accumulator, in which, for separating a fluid space that can be filled with mineral oil, such as hydraulic oil, the separator element is used to separate the latter from a fluid space filled with a process gas, such as nitrogen gas.

Although there have been repeated attempts in the prior art to create elastic, highly gas-tight plastic membranes with increased permeation resistance using a multilayer structure, which regularly involved the doctoring, spraying, pouring or brushing on of impregnating layers, it is now possible to obtain a functional membrane without such impregnating layers using basically only a 2-layer or preferably a 3-layer structure in a cost-effective manner, which can also be used in the long term in hydraulic accumulators of any kind. This is without parallel in the prior art.

Below, the separator element according to the invention is explained in more detail based on an exemplary embodiment according to the drawing. In the figures, in schematic representation, not to scale,

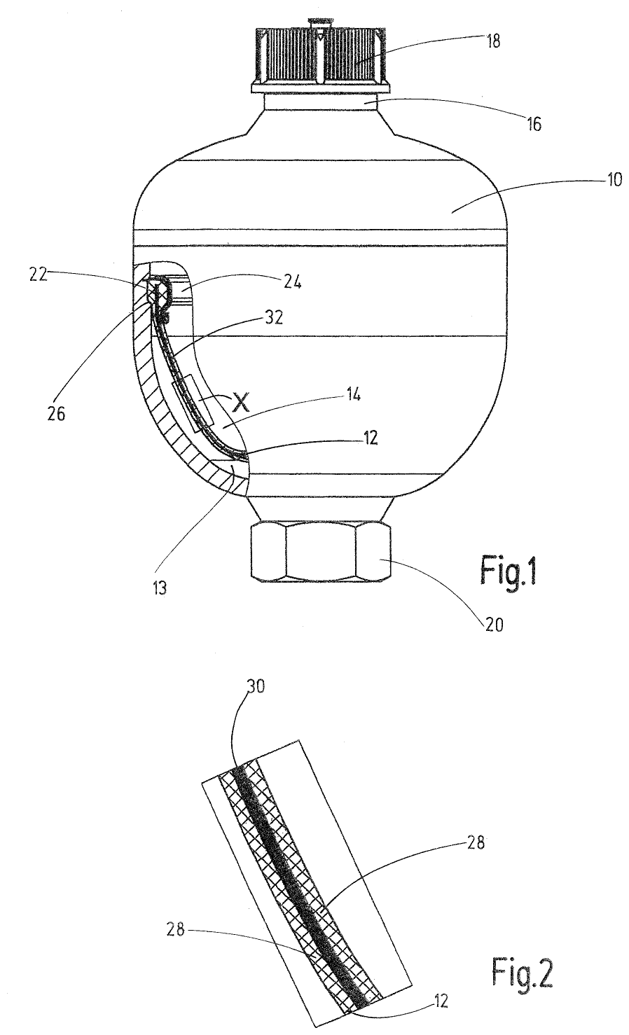

FIG. 1 shows the diaphragm accumulator with inserted separator element partly in view, partly in longitudinal section; and

FIG. 2 shows an enlarged view (5:1) of a section of the wall of a separator element of FIG. 1 labeled X.

FIG. 1 shows a pressure accumulator or hydraulic accumulator as a so-called diaphragm accumulator having an accumulator housing 10 in the form of a welded structure, in which a diaphragm 12 of multi-layer design separates a liquid side 13 from a gas side 14 as a movable separator element. A process gas, such as nitrogen gas, can be used to fill it via a filling port 16. The filling port 16 is covered by an end cap 18. On the fluid side 13 there is a fluid port 20 as a connection to a hydraulic system (not shown). In this respect, a hydraulic medium, such as mineral oil, reaches the fluid side 13 of the accumulator housing 10 from the side of the hydraulic system. In the central area of the diaphragm 12, on its end facing the fluid port 20, there may be a valve disk (not shown), which closes the fluid port 20 when the fluid side 13 is emptied and the diaphragm 12 is correspondingly extended. FIG. 1 shows the diaphragm 12 or the separator element in a position, in which a certain amount of liquid in the form of mineral oil is introduced onto the liquid side 13, thereby preloading the gas supply on the gas side 14 of the accumulator via the elastic diaphragm 12.

Pressure accumulators of this type, also in the form of so-called diaphragm accumulators, are state of the art and can be used in hydraulic systems as shock absorbers or pulsation dampers to dampen pressure surges in a hydraulic power circuit. Furthermore, they can be used as an energy source for a pumpless emergency circuit and are also suitable, for example, as hydraulic compression springs and the like in vehicles. Overall, hydraulic energy can be stored by preloading the gas supply on the gas side 14 of the accumulator.

The membrane 12 in the form of the separator element flares at its upper free end in a bulged rim 22. At this location of this bulged rim 22 the otherwise uniformly extending wall thickness of the accumulator housing 10 is provided with a wall recess with which the bulged rim 22 engages on the outer circumference, which bulged rim is held in this position by an inner circumferential metal clip 24, which is elastically flexible. In this way, the contact of the bulged rim 22 of the diaphragm 12 creates a fixed support 26 for the diaphragm 12 as a whole in the accumulator housing 10.

The diaphragm 12 as the separator element of the diaphragm accumulator is elastically flexible. An enlarged view of the laminate is shown in FIG. 2. In particular, according to the embodiment shown in FIG. 2, a three-layer laminate is implemented for the membrane 12, in which the two outer layers 28 form the one type that is resistant to mineral oils. The two layers 28 of the same thickness encase between them a layer 30 of the other type, which has low permeability to gases and is preferably completely gas-tight. In terms of wall thickness, this layer 30 is also approximately of the same thickness as the two rim layers 28 encasing the layer 30 to the outside.

The media-resistant layer 28 of one type is made of epichlorohydrin rubber, and the layer 30 of the other type is made of isobutene-isoprene rubber, which is to be regarded as gas-tight in this laminate shown in FIG. 2. The layers 28, 30 are firmly bonded together by vulcanization. Any stresses occurring between or in the laminate are eliminated by appropriate annealing. The shaping of the membrane 12 as a shell body can be achieved by thermoforming to form a kind of half shell 32. As further shown in FIG. 1, the bulged rim 22 formed from the outermost layers 28 is shaped as a receptacle, in which the upper free end of the middle layer 30 ends in such a way that the wall material of the bulged rim 22 still covers the free rim. It is particularly advantageous to select the specifications below for the different elastomer layers 28, 30:
Hardness 50 to 70 Shore A;
Elongation at break >400% (400% to 700%);
Strength >10 N/mm²; and
Temperature retraction <−10° C.

Owing to the use of different fluids at different temperatures and the requirements for flexibility, different demands are placed on the membrane materials, some of which are contradictory. For example, materials are used for low temperatures, but these usually have higher permeation values due to the required flexibility. Materials that achieve low-temperature flexibility with low permeation, on the other hand, may have problems with resistance to certain media and then cannot be used. By using two different materials (compounds), which are manufactured combined into one product, a highly flexible diaphragm 12 is created using ECO with good resistance to mineral oils and butyl with low gas permeability, which is media-resistant to mineral oils and, in the broadest sense, gas-tight to highly volatile process gases, such as nitrogen gas. This is without parallel in the prior art.

1. A separator element consisting of at least two types of layers of plastic material,
one type of which layers (28) is media resistant to mineral oils; and
the other type of which layers (30) has low permeability to gases or is gas-tight,
wherein the two types of layers (28, 30) are firmly bonded to each other when in direct contact, resulting the elastically flexible separator element (12).

2. The separator element according to claim 1, characterized in that a layer (30) of the other type is accommodated between two layers (28) of the one type across the entire surface.

3. The separator element according to claim 1, characterized more than three layers (28, 30, 28) are bonded together in that in alternating sequence, wherein preferably the outermost layers (28) in the laminate are media resistant to mineral oils.

4. The separator element according to claim 1, characterized in that the layer (28) of one type is made of epichlorohydrin rubber and the layer (30) of the other type is made of isobutene-isoprene rubber.

5. The separator element according to claim 1, characterized in that the bonded types of layers (28, 30) form a shell body, preferably in the manner of a half shell (32).

6. The separator element according to claim 5, characterized in that there is a thickened rim (22) at the free end half-shell-shaped laminate formed by the layers (28) of one type, into which the free end of the layer (30) of the other type opens out.

7. A method of manufacturing a separator element according to claim 5, characterized in that the respective types of a layer (28, 30) are a sheeting; and in that the layers (28, 30) are bonded together by thermoforming to form the shell body.

8. The method of manufacturing a separator element according to claim 5, characterized in that the respective types of layer (28, 30) assumes the shape of the shell body as a partial body by means of thermoforming, and that subsequently the partial bodies are bonded to each other by vulcanization to form the shell body as a whole.

9. The method for producing a separator element according to claim 7, characterized in that the thermoforming, respectively the vulcanizing, is followed by a manufacturing step of annealing.

10. A hydraulic accumulator, in particular a diaphragm accumulator, in which a separator element (12) according to claim 1 is used to separate a fluid space (13), which can be filled with mineral oil, such as hydraulic oil, from a fluid space (14) filled with a process gas, such as nitrogen gas, and in that one type of layer (28) of the separator element (12) is arranged adjacent to the fluid space (13) holding the mineral oil in one accumulator housing (10).

11. A separator element consisting of at least two types of layers of plastic material,
one type of which layers (28) is media resistant to mineral oils; and
the other type of which layers (30) has low permeability to gases or is gas-tight,
wherein the two types of layers (28, 30) are firmly bonded to each other when in direct contact, resulting the elastically flexible separator element (12),
wherein the two outer layers (28) consist of one type of epichlorohydrin rubber and receive a layer (30) of the other type between them,
characterized
in that the layer (30) of the other kind between the two layers (28) of the one kind is made of isobutene-isoprene rubber;
in that all layers (28, 30) consist of a single layer each;
in that the respective type of layer (28, 30) is formed into the shape of a shell body as a partial body by means of thermoforming; and
in that the three individual partial bodies are subsequently bonded together by vulcanization to form an overall shell body.
